(19) United States
(12) Patent Application Publication
(10) Pub. No.: US 2010/0218672 A1
(43) Pub. Date: Sep. 2, 2010

(54) Reciprocating Piston Machine

(76) Inventors: Tilo Schäfer, Daubach (DE); Jan Hinrichs, Friedrichsdorf (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/680,615

(22) PCT Filed: Sep. 13, 2008
(86) PCT No.: PCT/EP08/07584

§ 371 Date: Mar. 29, 2010

(30) Foreign Application Priority Data
Oct. 2, 2007 (DE) 10 2007 048 629.6

(51) Int. Cl. F16J 10/00

(52) U.S. Cl. 92/169.1

(57) ABSTRACT

A reciprocating piston machine, in particular a swash ring compressor or swash plate compressor, with pistons which are received so as to be movable in a reciprocating manner in cylinder spaces of a cylinder block with a cylinder head made from a material of lower strength such as aluminum material and which are driven by a driving mechanism which is arranged in a driving mechanism housing part made from a material of higher strength such as steel material. The driving mechanism housing part made from the material of higher strength is fastened to the cylinder block which is made from a material of lower strength such as aluminum material.

### PRIORITY CLAIM

This is a U.S. national stage of application No. PCT/EP2008/007584, filed on Sep. 13, 2008. Priority is claimed on the following application(s): Country: Germany, Application No.: 10 2007 048 629.6, Filed: Oct. 2, 2007, the content of which is/are incorporated here by reference

### FIELD OF THE INVENTION

The invention is directed to a reciprocating piston machine, in particular a swash ring compressor or swash plate compressor, with pistons which are received so as to be movable in a reciprocating manner in cylinder spaces of a cylinder block with a cylinder head made from a material of lower strength such as aluminum material and which are driven by a driving mechanism which is arranged in a driving mechanism housing part made from a material of higher strength such as steel material.

### BACKGROUND OF THE INVENTION

The international publication WO 02/095229 A1(US2004/191080 A1) discloses a compressor with a cylinder head produced from an aluminum material and a housing cup and housing cover which are produced from steel or comparable materials. The international publication WO 2004/005712 A1 (US2006/207423 A1) discloses a reciprocating piston machine with a cylinder head of aluminum and a housing of steel. The German Laid Open Application DE 198 33 604 A1 (U.S. Pat. No. 6,026,731) discloses a compressor with a housing of composite material.

It is the object of the invention to provide a reciprocating piston machine, in particular a swash ring compressor or swash plate compressor, having pistons which are received so as to be movable in a reciprocating manner in cylinder spaces of a cylinder block with a cylinder head made from a material of lower strength such as aluminum material and which are driven by a driving mechanism which is arranged in a driving mechanism housing part made from a material of higher strength such as steel material, which reciprocating piston machine has a long life and can be produced economically.

In a reciprocating piston machine, in particular a swash ring compressor or swash plate compressor, having pistons which are received so as to be movable in a reciprocating manner in cylinder spaces of a cylinder block with a cylinder head made from a material of lower strength such as aluminum material and which are driven by a driving mechanism which is arranged in a driving mechanism housing part made from a material of higher strength such as steel material, the above-stated object is met in that the driving mechanism housing part made from the material of higher strength is fastened to the cylinder block which is made from a material of lower strength such as aluminum material. According to an essential aspect of the invention, the parting plane between the higher-strength material and the lower-strength material lies between the driving mechanism housing part and the cylinder block. Accordingly, the weight of the reciprocating piston machine can be reduced without compromising its strength in an unwanted manner.

A preferred embodiment of the reciprocating piston machine is characterized in that the cylinder block and the cylinder head are formed of an aluminum material. The cylinder block and the cylinder head are preferably formed from the same aluminum material.

Another preferred embodiment of the reciprocating piston machine is characterized in that the driving mechanism housing part is formed of steel. The driving mechanism housing part is preferably constructed as an extruded part.

Another preferred embodiment of the reciprocating piston machine is characterized in that the driving mechanism housing part comprises a thin-walled steel jacket. The steel jacket has substantially the shape of the outer surface of a right circular cylinder.

Another preferred embodiment of the reciprocating piston machine is characterized in that the cylinder block is fastened to the cylinder head by screws. A valve plate is preferably clamped between the cylinder block and the cylinder head.

Another preferred embodiment of the reciprocating piston machine is characterized in that the cylinder block has a male thread portion which is screwed into a female thread portion of the driving mechanism housing part. The preassembled unit comprising cylinder block and cylinder head is preferably screwed together with the driving mechanism housing part.

### BRIEF DESCRIPTION OF THE DRAWINGS

Other advantages, features and details of the invention are evident from the following detailed description of an embodiment with reference to the drawing in which.

FIG. 1 is a schematic sectional view of the reciprocating piston machine according to the present invention.

### DETAILED DESCRIPTION OF THE PRESENTLY PREFERRED EMBODIMENTS

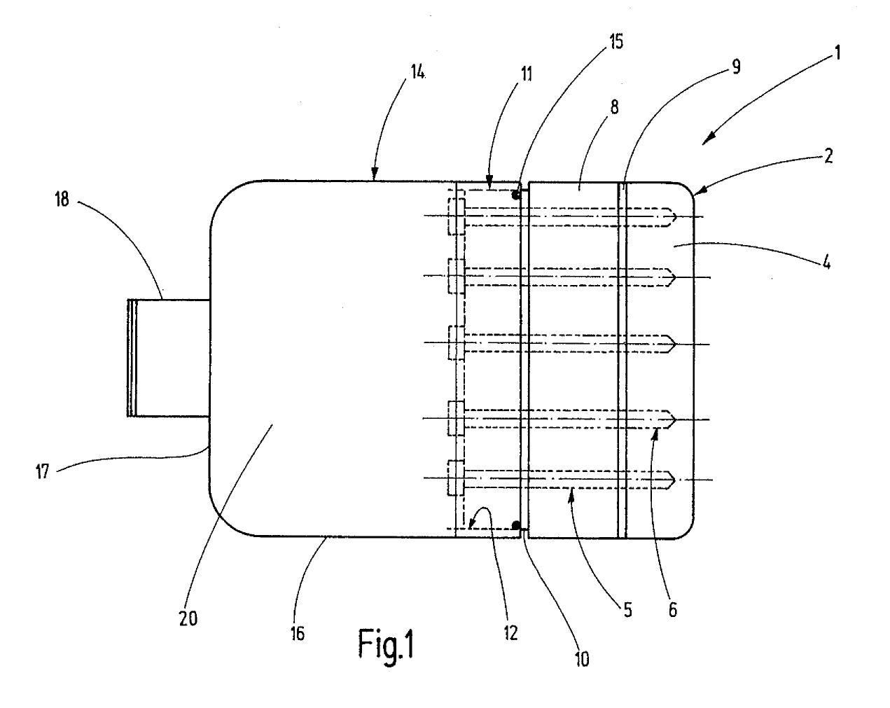

A reciprocating piston machine 1 such as is disclosed, for example, in International Patent Application WO 99/24715 A1, the content of which is incorporate herein by reference is shown in simplified form in FIG. 1. The reciprocating piston machine 1 has seven pistons, for example, which are arranged adjacent to one another in circumferential direction of the machine and are guided in cylinder bores. The reciprocating movement of the pistons is carried out in that a ring disk extending diagonally relative to a machine shaft engages in an engagement chamber adjoining a closed cavity of the piston.

The reciprocating piston machine 1 comprises a housing 2 which is partially formed by a cylinder head 4. The cylinder head 4 comprises a plurality of threaded blind holes into which screws 5, 6 are screwed. The screws 5, 6 serve to fasten a cylinder block 8 to the cylinder head 4. A valve plate 9 through which the screws 5, 6 engage is clamped between the cylinder block 8 and the cylinder head 4.

The cylinder block 8 has the shape of a right circular cylinder, for example, and has at its side remote of the cylinder head 4 a shoulder 10 having a male thread 11 on which a female thread 12 of a driving mechanism housing part 14 is screwed. The driving mechanism housing part 14 is fixedly and tightly connected to the cylinder block 8 with the intermediary of a seal 15.

The driving mechanism housing part 14 comprises a jacket 16 which has the shape of an outer surface of a right circular cylinder. One front side of the jacket 16 is closed by the cylinder block 8. The other front side of the jacket 16 is closed by a cover 17 having a journal 18 for a belt pulley (not shown). In its interior, the driving mechanism housing part 14 defines a driving space 20 for a driving mechanism for driving the pistons of the reciprocating piston machine 1.

According to an essential aspect of the invention, the cylinder block 8 and the cylinder head 4 are both formed of aluminum, for example, an aluminum material, since these parts are subject to low thermal stresses. In contrast, the driving mechanism housing part 14 is high loaded thermally and also in terms of strength. Therefore, the driving mechanism housing part 14 is formed of steel.

In comparison to the conventional reciprocating piston machines, the parting plane between the aluminum parts and the steel parts is shifted closer to the driving mechanism housing part cover 17. The reciprocating piston machine according to the invention is characterized by great robustness with respect to resistance to temperature and relative to rotational speed, but is appreciably lighter, for example, by one kilogram, than conventional reciprocating piston machines.

The invention is not limited by the embodiments described above which are presented as examples only but can be modified in various ways within the scope of protection defined by the appended patent claims.

1-6. (canceled)

7. A reciprocating piston machine comprising:
a cylinder block having cylinder spaces and a cylinder head each made from a material of relatively lower strength;
a plurality of pistons reciprocatingly moveable within said cylinder spaces;
a driving mechanism housing part and a driving mechanism disposed within said housing part, said housing part being made of a material of relatively higher strength; said driving mechanism housing part made from the material of relatively higher strength being fastened to said cylinder block made from the material of relatively lower strength.

8. The reciprocating piston machine according to claim 7, wherein said cylinder block and said cylinder head are formed of an aluminum material.

9. The reciprocating piston machine according to claim 7, wherein said driving mechanism housing part is formed of steel.

10. The reciprocating piston machine according to claim 8, wherein said driving mechanism housing part is formed of steel.

11. The reciprocating piston machine according to claim 7, wherein said driving mechanism housing part comprises a thin-walled steel jacket.

12. The reciprocating piston machine according to claim 7, wherein said cylinder block is fastened to said cylinder head by screws.

13. The reciprocating piston machine according to claim 7, wherein said cylinder block additionally comprises a male thread portion and said driving mechanism housing part comprises a female thread portion for fastening said male portion to said female portion.

14. The reciprocating piston machine according to claim 10, wherein said driving mechanism housing part comprises a thin-walled steel jacket.

15. The reciprocating piston machine according to claim 10, wherein said cylinder block is fastened to said cylinder head by screws.

16. The reciprocating piston machine according to claim 10, wherein said cylinder block additionally comprises a male thread portion and said driving mechanism housing part comprises a female thread portion for fastening said male portion to said female portion.

17. The reciprocating piston machine of claim 7, wherein said machine is one of a swash ring compressor and a swash plate compressor.
